(19) United States
(12) Patent Application Publication
(10) Pub. No.: US 2025/0162838 A1
(43) Pub. Date: May 22, 2025

(54) SYSTEM AND METHOD FOR AUTOMATICALLY MODIFYING ELEVATOR WORKFLOW BASED ON INCIDENT TYPE

(71) Applicant: MOTOROLA SOLUTIONS, INC., CHICAGO, IL (US)

(72) Inventors: CHUN HOCK LEE, SUNGAI PETANI (MY); HUI BOON CHUA, SUNGAI PETANI (MY); WEI HAN NGAN, TELUK INTAN (MY); JIA MIN MOON, BAYAN LEPAS (MY)

(21) Appl. No.: 18/513,727

(22) Filed: Nov. 20, 2023

(51) Int. Cl. B66B 5/02

(52) U.S. Cl. CPC B66B 5/025

(57) ABSTRACT

Techniques for automatically modifying elevator workflow based on incident type are provided. An incident occurring within an elevator is detected via a video camera. Video analytics are used to determine the incident type. It is determined that a floor selection associated with the incident type will place elevator passengers or people on the selected floor at risk. Elevator workflow execution is automatically modified based on the incident type and risk associated with the floor selection. The floor selection is displayed while modifying the elevator workflow to a different floor. A security notification indicative of the incident type and the automatic modification of the elevator workflow is sent.

### BACKGROUND

Studies have shown that an average office building elevator runs about ten hours a day making over four hundred thousand trips a year. In addition, more and more housing is being further concentrated in multiple story buildings leading to even more elevators. As the density of multi-story office and residential buildings increase, people will spend every increasing portions of their time inside of elevators while being transported to their desired destination. This is further exacerbated by the ever-increasing height of buildings, which requires even more time to be transported over greater distances.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is an example of an environment in which the automatically modifying elevator workflows based on incident type techniques described herein may be utilized.

FIG. 2 is an example of a flow diagram that implements the techniques described herein.

FIG. 3 is an example of a device that may be used to implement the techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

As people spend more and more time inside of elevators, a problem arises in that there becomes a greater chance that an incident may occur while the person is inside an elevator. For example, a person inside an elevator may experience a medical emergency (e.g. heart attack, person becomes unconscious, etc.). As yet another example, if multiple people are within an elevator, an incident can be robbery/assault incidents. Incidents may also include elevator malfunction (e.g. failure of doors to open, etc.). Loitering within an elevator is yet another possible incident. A child trapped within an elevator is yet another type of incident.

Although a few specific types of incidents are described, it should be understood that this is an exemplary list of incident types and is not intended to be limiting. The techniques described herein may be utilized with any type of incident. What should be understood is that an incident may occur while an elevator passenger is effectively trapped within the elevator until the selected destination floor is reached.

Furthermore, the elevator doors opening once the selected destination floor is reached could cause even further danger to elevator occupants. For example, in a case where an assault is occurring on an elevator and the destination floor is relatively empty, the assailant may drag the victim off of the elevator to an isolated portion of the building. In the case of a medical emergency, the selected destination may place the person experiencing the medical emergency even further away from assistance (e.g. the selected destination is the penthouse of a 70 story building while medical responders will be arriving at the ground floor of the building).

The techniques described herein solve these technical problems individually and collectively. A video camera that is capable of detecting incidents is included in an elevator. For example, the video camera may detect abnormal motion within the elevator. For example, a person in an elevator dropping to the floor may be considered an abnormal motion within the elevator.

Using video analytics on the image stream from the video camera, it can be determined the type of the incident that is occurring. For example, if a person is alone in an elevator suddenly collapses to the floor, video analytics may determine that the person is experiencing a medical emergency type of incident. On the other hand, if there are two people in the elevator, one person may have assaulted the other person, causing them to fall to the floor. Thus, in that case, the incident type may be an assault.

The system may then determine that a current floor selection of the elevator (e.g. the currently selected destination floor) may place either passengers within the elevator or people waiting on the destination floor at risk. For example, if an elevator passenger is an active shooter carrying a gun, people waiting for the elevator on the current selected destination floor would be placed at risk due to the fact that the elevator doors would open and there would be an active shooter emerging.

Once it is determined that the current destination floor would put either current passengers in the elevator or people on the current destination floor at risk, the elevator workflow may be automatically modified based on the type of incident and the risk associated with the selected destination floor. For example, in some cases (e.g. the medical incident, etc.) the elevator workflow may be modified to cause the elevator to return to the ground floor where a medical response team would initially arrive. In other cases (e.g. active shooter on the elevator), the elevator workflow may be modified to cause the elevator to go to a floor where security personnel are available and able to respond to the active shooter. What should be understood is that the modification of the elevator workflow is based on the incident type as well as the incident severity as opposed to a simple command to return to the ground floor.

For incident types involving a bad actor (e.g. active shooter, person committing assault, etc.) it may be desirable to not let the bad actor know his activities have been detected and the elevator is being sent to a floor different than the originally selected destination floor. This may be done so that the bad actor is not aware that there will be a response (e.g. a security personnel and/or police response waiting when the elevator doors open. In order to achieve this result, all indicators within the elevator (e.g. floor number display, destination floor selection, etc.) may continue to reflect the selected destination floor, even if the elevator workflow is modified to send the elevator to a different floor.

A security notification indicative of the incident type and what automatic modification of the elevator workflow was made may be sent to security personnel. Security personnel may include building security associated with the building where the elevator is located or it may include public safety personnel (e.g. police, fire department, emergency medical services (EMS), etc.). For example, in the case of a medical incident, a notification may be sent to local EMS to dispatch responders to the building where the elevator is located. The notification may be used to direct building security personnel to the different floor selected by the automatic modification.

A method is provided. The method comprises detecting, via a video camera, an incident occurring within an elevator. The method also comprises determining incident type using video analytics. The method also comprises determining that a floor selection associated with the incident type will place at least one of elevator passengers or people on the selected floor at risk. The method also comprises automatically modifying elevator workflow execution based on the incident type and risk associated with the floor selection. The method also comprises displaying the floor selection, while modifying the elevator workflow to a different floor. The method also comprises sending a security notification indicative of the incident type and the automatic modification of the elevator workflow.

In one aspect, the method further comprises dispatching security personnel to the different floor. In one aspect, the method further comprises keeping a door of the elevator closed until security personnel have arrived at the different floor. In one aspect, the method further comprises sending at least a portion of a feed from the video camera to a device associated with security personnel. In one aspect, the method further comprises preventing other elevators from stopping on the different floor. In one aspect, the method further comprises removing the elevator from service, wherein removing the elevator from service prevents the elevator from responding to additional calls.

A system is provided. The system includes a processor and a memory coupled to the processor. The memory contains a set of instructions thereon that when executed by the processor cause the processor to detect, via a video camera, an incident occurring within an elevator. The instructions on the memory also cause the processor to determine incident type using video analytics. The instructions on the memory also cause the processor to determine that a floor selection associated with the incident type will place at least one of elevator passengers or people on the selected floor at risk. The instructions on the memory also cause the processor to automatically modify elevator workflow execution based on the incident type and risk associated with the floor selection. The instructions on the memory also cause the processor to display the floor selection, while modifying the elevator workflow to a different floor. The instructions on the memory also cause the processor to send a security notification indicative of the incident type and the automatic modification of the elevator workflow.

In one aspect, the system further comprises instructions that cause the processor to dispatch security personnel to the different floor. In one aspect, the system further comprises instructions that cause the processor to keep a door of the elevator closed until security personnel have arrived at the different floor. In one aspect, the system further comprises instructions that cause the processor to prevent other elevators from stopping on the different floor. In one aspect, the system further comprises instructions that cause the processor to remove the elevator from service, wherein removing the elevator from service prevents the elevator from responding to additional calls.

A non-transitory processor readable medium containing a set of instructions thereon is provided. The instructions, that when executed by a processor, cause the processor to detect, via a video camera, an incident occurring within an elevator. The instructions on the medium also cause the processor to determine incident type using video analytics. The instructions on the medium also cause the processor to determine that a floor selection associated with the incident type will place at least one of elevator passengers or people on the selected floor at risk. The instructions on the medium also cause the processor to automatically modify elevator workflow execution based on the incident type and risk associated with the floor selection. The instructions on the medium also cause the processor to display the floor selection, while modifying the elevator workflow to a different floor. The instructions on the medium also cause the processor to send a security notification indicative of the incident type and the automatic modification of the elevator workflow.

In one aspect, the instructions on the medium cause the processor to dispatch security personnel to the different floor. In one aspect, the instructions on the medium cause the processor to keep a door of the elevator closed until security personnel have arrived at the different floor. In one aspect, the instructions on the medium cause the processor to prevent other elevators from stopping on the different floor. In one aspect, the instructions on the medium cause the processor to remove the elevator from service, wherein removing the elevator from service prevents the elevator from responding to additional calls.

In one aspect, automatically modifying the elevator workflow execution based on incident type is further based on a determination of an incident severity. In one aspect, automatically modifying elevator workflow execution comprises at least one of, stopping the elevator, modifying elevator floor destination, modifying elevator floor destination in conjunction with a false destination indicator, increasing or decreasing elevator speed, automatically enabling an intercom, automatically controlling the elevator to nearest floor with security, and automatically directing the elevator to a floor with exits. In one aspect, the security notification is sent to a public safety answering point (PSAP). In one aspect, the PSAP can override the modified elevator workflow execution.

Each of the above-mentioned embodiments will be discussed in more detail below, starting with an overall environment in which the automatically modifying elevator workflow based on incident type techniques may be implemented. This is followed by an illustration of processing blocks for achieving an improved technical method, device, and system for automatically modifying elevator workflow based on incident type techniques described herein. The description concludes with an architecture of device(s) which may implement the techniques described herein.

Further advantages and features consistent with this disclosure will be set forth in the following detailed description, with reference to the figures.

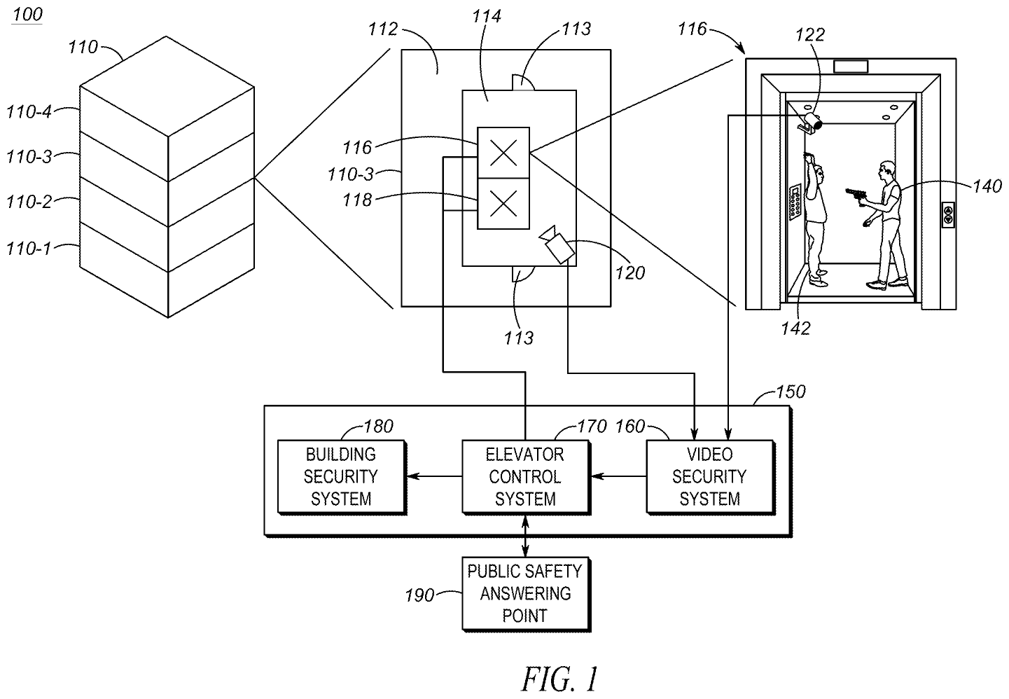

FIG. 1 is an example of an environment 100 in which the automatically modifying elevator workflows based on incident type techniques described herein may be utilized. The environment includes a building 110 and various building systems 150.

The building 110 may be any type of building that includes at least one elevator. In the example shown in FIG. 1, the building includes four floors labeled as 110-1-4. It should be understood that this is for ease of description only. The techniques described herein are not limited by building size and would be suitable for use in any building that includes at least one elevator. It should further be noted that the building need not be above ground. Buildings with subterranean floors could also implement the techniques described herein.

The third floor 110-3 is expanded in floor plan 112 to show the layout of an individual floor of building 110. In many cases, all floors of a building will have generally the same layout, although this is not necessary. However, given the nature of elevators, the placement of elevators will generally be the same on every floor, as the elevator shafts are required to align from the top to the bottom of the building.

As shown in the example floor plan, there is an elevator lobby 114. Within the elevator lobby, there are two elevators 116, 118. These elevators allow people to travel between floors of the building 110. In some implementations, the elevator lobby for a floor may be separated from the overall floorplan 112 of the floor via one or more security doors 113. The security doors may allow a person to access a given floor's elevator lobby, but not necessarily the entire floor itself.

For example, a business may have an office on a certain floor of a building while other areas of the building are used by other tenants. It would be undesirable for a visitor in a building to be allowed to simply select the floor where the business is located and the elevator opens up directly into what should be a private space for the building. By restricting access to the elevator lobby only, a visitor may be able to arrive at the floor of the business, but would not be able to leave the elevator lobby until someone allows them to pass through the security door 113.

The elevator lobby 114 may also include one or more video cameras 120 whose field of view covers the elevator lobby. The video camera may be connected to a video security system 160 which is described in further detail below. The video camera may surveil the elevator lobby to provide a visual representation of the elevator lobby to the video security system which may be used to detect incidents as well as other functionality.

A detailed view of elevator 116 is provided. Elevator 118 may be similarly structured. Elevator 116 may include all the known features of an elevator (e.g. doors, lights, destination floor selection buttons, floor display indications, etc.) (not shown). In addition, the elevator 116 may be equipped with a video camera 122 whose field of view includes the interior of the elevator. The video camera within the elevator may also be connected to video security system 160.

The elevators 116, 118 may also be connected to the elevator control system 170. The elevator control system directs the elevator operation via workflows. The elevators receive instructions from the elevator control system and follow those instructions. For example, the elevator may be instructed to travel to a certain floor and cause the doors to open once the floor is reached. The elevator control system may instruct the elevator to return to the ground floor of the building. What should be understood is that the elevators follow the instructions of the elevator control system.

Video security system 160 may receive video feeds from cameras 120, 122 and perform video analytics on those video feeds. One example of the analytics that may be performed is incident detection. Incident detection may involve initially training a camera on what the field of view should normally look like. The video security system may then note abnormalities in what is expected to be seen, which is sometimes referred to as unusual motion.

Upon detection of an incident, the video security system may perform video analytics to determine the type of incident that is occurring. For example, a person dropping to the floor within an elevator may be considered an unusual motion and would be considered an incident. The video analytics could then be run to determine the type of incident. For example, if the person is alone and fell to the floor, it is likely a medical incident. If the person was pushed to the floor by another it is likely an assault.

It should be noted that detecting incidents and using video analytics to determine incident type using various algorithms is known. The techniques described herein may be utilized with any currently known or later developed video analytics. What should be understood is that the video security system is able to identify incidents and their types.

The elevator control system 170 is used to control the elevator workflows. For example, the elevator control system directs the elevators as to which floors they should go to, when the doors should open, when the doors should close, what should be displayed on the elevator displays, etc. The elevator control system can be used to direct the elevator to go to any floor it desires, regardless of the floor selection of people on the elevator.

The elevator control system 170 may also utilize the video feeds from the video cameras 120, 122 to determine the level of risk and/or risk severity for elevator passengers as well as people waiting in the elevator lobby 114 of each floor. As will be explained below, the elevator control system may direct the elevator to go to a different floor than the one that was originally selected based on the level of risk should the elevator go to the originally selected floor.

The building security system 180 may be the system utilized by security personnel within the building 110 to manage responses to incidents. For example, most buildings of any significant size may have one or more security guards. The security guards may be able to provide protective services or initial medical services to persons within a building. The building security system may include dispatch capabilities to cause security guards to be dispatched to desired locations. For example, security guards may be equipped with portable radios (e.g. walkie-talkies, etc.). The building security system may use these radios to dispatch security guards to locations where they are needed.

In some cases, the security guards may be equipped with devices that can be used to determine their location within the building. For example, their radios may global positioning service (GPS) capabilities so the location of the security guard within the building is known. This knowledge may be utilized when dispatching a security guard in order to dispatch the security guard that is closest to the incident to a certain location. In some cases, the current location of the security guard may be utilized to determine where an elevator is directed to go.

The environment 100 may also include an interface to a public safety answering point (PSAP) 190. A PSAP is an interface to public safety services (e.g. police, fire, emergency medical services, etc.) through which a response from public safety personnel may be requested. The most commonly used PSAP is a 911 call center. However, there can also be direct machine to machine connections between systems such as the elevator control system 170 and the PSAP. The PSAP may be notified when incidents occur in order to provide a response. In some cases, modification of elevator workflows is further modified by the PSAP.

Operation of the environment 100 will be presented in terms of several use cases. In the first use case, assume there is an assailant 140 who is attempting to rob a victim 142 at gunpoint inside an elevator 116. The video security system 160 may determine that an incident is occurring because a person holding their arms up within an elevator is an unusual motion. The video security system may run video analytics to identify the gun. The video analytics system may determine that the incident type is an armed robbery based on the presence of the gun and the victim with their hands up.

This information may then be passed to the elevator control system 170. The elevator control system may analyze the original selected destination floor of the elevator and determine if there would be people placed at risk should the elevator go to the originally selected destination floor. For example, if the elevator control system, through the video security system 160 and elevator lobby camera 120 determines that the current destination floor has people waiting within the elevator lobby 114, those people would be at risk when the elevator doors open and the people are confronted with an armed gunman.

To reduce this risk, the elevator control system 170 may identify a floor where there is no one waiting for the elevator. The elevator control system may modify the elevator workflow to cause the elevator to go to the identified floor. In some cases, the elevator control system may use the interface to the building security system 180 to cause security guards to be deployed to the newly selected destination floor. In some cases, the current location of the security guards may be used to select the new destination floor. For example, if there is already a security guard on the third floor, the elevator may be directed to stop on the third floor.

In some cases, the elevator control system 170 may aid the security guard by decreasing the elevator speed and keeping the doors to the elevator 116 closed until the security guard arrives. For example, the original destination floor may have been the second floor. Because there were people waiting on the second floor when the armed gunman incident was detected, the elevator may have been directed to go to the fourth floor and security guards dispatched to the fourth floor. The speed of the elevator may be decreased to allow more time for the security guards to arrive at the fourth floor. If the elevator arrives before the security guard, the elevator control system may keep the gunman trapped within the elevator by keeping the door closed until the security guard arrives.

In order to better prepare the security guard, the video captured by the video camera 122 inside the elevator may be streamed to a device (e.g. walkie-talkie, smartphone, etc.) associated with the security guard in order that the security guard may see what is going on inside the elevator.

In order to not arouse the suspicion of people inside the elevator 116, the elevator control system 170 may cause the displays within the elevator to display false information. For example, if the originally selected destination floor was the second floor, the indicator within the elevator will continue to reflect this, even though the elevator is being directed to a different floor. Likewise, any indicator within the elevator used to indicate the current floor the elevator is on/passing through may be falsified such that the elevator occupants are not aware of the true newly selected destination floor. Displaying the floor selection that was originally selected helps to ensure the occupants of the elevator are not aware that a response to the incident has been put into motion.

Just as the elevator control system 170 can use the building security system to dispatch security guards to the newly selected destination floor, there can also be a request for assistance from a PSAP 190. In the present example of an armed robbery, a response to the incident may be requested from a PSAP. Initially the elevator control system may not know to which floor the PSAP responder will arrive and may select a floor based on other information. The officer responding to the PSAP request may arrive and modify the elevator workflow to select a destination floor determined by the officer. In other words, the new floor selected by the PSAP officer is overridden by the officer.

The elevator control system 170 may take additional actions to prevent additional people from being placed at risk. For example, once an incident is detected, the elevator 116 where the incident is detected may be taken out of service. This means the elevator will no longer answer calls for service. For example, if the elevator was traveling from floor one to floor four, and someone on floor two elevator lobby pressed the up button, the elevator 116 if in service would answer that call. By taking the elevator out of service, the person waiting on floor two is not confronted with an armed gunman. Likewise, if the elevator is being directed to a different floor (e.g. for a security guard and/or public safety response, etc.) other elevators 118 may be diverted from that floor (e.g. no other elevators are allowed to stop on the floor where elevator 116 is being directed).

Another use case may be where a child is trapped inside an elevator. A small child alone in an elevator is an unusual event that may indicate an incident is occurring. The video security system 160 may detect the incident. The video analytics may detect that the child is crying and is without any parental supervision, indicating a possible potentially trapped inside an elevator.

In response, the nearest security guard may be identified using GPS location of the security guards. Video of the child could be presented to the security guard so he understands the situation. The elevator control system can direct the elevator to go to the closest floor with a security guard. In some cases, and intercom may be used to talk to the child in an attempt to calm the child down.

As above, the elevator may be taken out of service, such that no additional people are able to board the elevator thus protecting the unaccompanied child from strangers. The doors of the elevator may remain closed until the security guard arrives. The floor where the elevator has been directed can stop other elevators from stopping on that floor until the child has been attended to by the security guard.

As yet another example, the video security system 160 may have detected a person fallen in an elevator which would be unusual. Video analytics may be used to determine that the person is experiencing a medical emergency. The system may send a request to the PSAP 190 for medical assistance. The elevator workflow may be modified to cause the elevator to immediately return to the ground floor, as that is where the PSAP responders will arrive. In some cases, depending on the urgency of the situation, the elevator speed may be increased in order to get the person in need of medical attention to a location where medical attention can be provided as quickly as possible. Just as above, the elevator can be taken out of service so it reached its destination as quickly as possible.

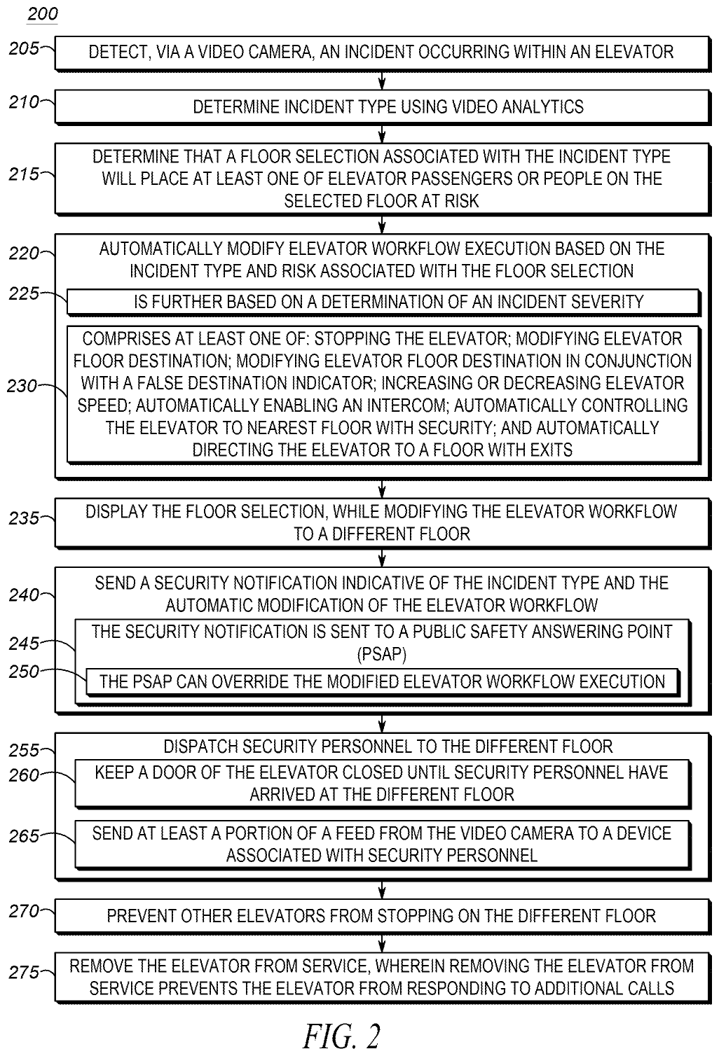

FIG. 2 is an example of a flow diagram 200 that implements the techniques described herein. In block 205, an incident occurring within an elevator may be detected via a video camera. As described above, and elevator may be equipped with video cameras, such as closed circuit television (CCTV) cameras. These cameras may have a field of view that includes the interior of the elevator. There are many known techniques to determine that there is an incident occurring within the elevator. One such example is abnormal motion detection. In some cases, cameras can utilize artificial intelligence to monitor the field of view of the camera to determine what is considered normal motion within that field of view.

If the camera identifies abnormal motion within the field of view, it can determine that there is an incident occurring within the elevator. Abnormal motion may include persons fallings down, unattended children in the elevator, fights being detected in the elevator. The techniques described herein are not dependent on any particular technique for determining that an incident is occurring within the elevator. Any currently available or later developed techniques for determining an incident is occurring within the elevator are suitable for use with the techniques described herein.

In block 210, an incident type may be determined using video analytics. There are many known techniques for using video analytics to determine what is occurring in a field of view of the camera. For example, there are fall detection video analytics that may determine if a person has fallen, there are assault/fight detection video analytics to determine if a person is being assaulted or is engaged in a fight, there are loitering video analytics to determine if a person is remaining in an area without any apparent reason to be there. What should be understood is that video analytics are used to identify the type of incident that may be occurring within the elevator.

The techniques described herein are not limited to any particular type of video analytics.

Any currently available or later developed video analytic may be used to determine what type of incident is occurring within the elevator. The type of incident may be used to determine the how the elevator workflow is modified.

In block 215, it may be determined that a floor selection associated with the incident type will place at least one of elevator passengers or people on the selected floor at risk. As described above, the floor selection is the initial desired destination floor for the elevator. For example, a person enters an elevator and presses the button for the tenth floor, indicating that that floor is the desired destination.

Based on the incident type, it may be determined that going to the selected destination floor would either put someone on the elevator or someone on the selected destination floor at risk. For example, in a medical emergency, going to the selected destination floor may put an elevator passenger experiencing the emergency at risk, because there may be no one available to assist with the medical incident at the selected floor. Likewise, in some situations, people currently on the selected destination floor may be placed at risk if the elevator doors were to open on the selected destination floor. For example, in a situation where an active shooter has gone into the elevator, persons already on the selected destination floor may be placed at risk, as they would not be aware that an active shooter will appear. Those persons may have simply been waiting for the elevator, and when the doors open, the active shooter would appear.

The system may utilize cameras from the video system to identify people on the various floors. As described above, the system may include cameras whose field of view includes the elevator lobbies of each floor of a building. Using these cameras, the system can determine the number and/or type of people who may be waiting in the elevator lobby of each floor.

In block 220, elevator workflow is automatically modified based on the incident type and risk associated with the floor selection. In other words, a floor different than the one initially selected as the destination floor selection will be chosen as the destination floor for the elevator. The modification of the workflow may be based on the incident type. For example, for a medical incident, the workflow may be modified to cause the elevator to move to the ground floor, regardless of the floor that was originally selected. The modification of the elevator workflow is also based on the risk associated with the floor selection.

For example, in an active shooter incident, a floor that has people waiting for the elevator is at greater risk than a floor that does not have people waiting for the elevator. Thus, when selecting a floor to send the elevator to a floor with no people waiting may be selected as there would be less risk than selecting a floor where people are waiting for the elevator.

In block 225, the modification of the elevator workflow is based on a determination of an incident severity. For example, the incident severity could be based on if there is an immediate danger to persons on the elevator/waiting in the elevator lobby, if there is a person on the elevator threatening others, if a person is trapped on an elevator, if a person on an elevator is panicking, etc. What should be understood is that the incident severity may play a role in determining how the elevator workflow is modified.

For example, in the case where there is an active shooter, which might have a very high severity level, the elevator workflow may be modified to select a destination floor whose elevator lobby is empty, thus reducing risk to people waiting for the elevator, as well as cause the elevator doors to remain closed until building security personnel are able to arrive at the newly selected destination floor to apprehend the suspect.

In block 230, the modification of the elevator workflow comprises at least one of the following modifications. One modification may include stopping the elevator. For example, in the case where an individual is alone in an elevator and has been identified as causing a problem of some type, the elevator workflow may be modified to simply stopping the elevator, leaving the bad actor trapped in the elevator. Apprehension of the individual by either building security or law enforcement is made easier as the location of the subject is fixed.

Another example includes modifying elevator floor destination. As explained above, the destination floor may be modified to ensure that there are sufficient resources (e.g. medical personnel, security personnel, law enforcement, etc.) available to deal with the incident at the newly selected destination floor. In short, the elevator can be directed to a floor where personnel are available to deal with whatever incident has occurred. In some cases, the selection of the floor may be based on the fact that there is no one waiting in the elevator lobby on the selected floor.

As yet another example, the elevator floor destination is modified in conjunction with providing a false destination indicator. In some cases, it may be desirable to not let the person on the elevator involved in the incident to know that their actions have been detected and that corrective action is being taken. For example, if there is an active shooter on an elevator who has selected the tenth floor as the destination, changing the selected destination to a different floor would provide information to the active shooter that his activities have been detected and that he is being redirected to a floor where there will be a response waiting. By providing a false destination indicator (e.g. keeping the destination indicator as the initially selected destination floor) the bad actor is not aware that their activities have been detected.

As yet another example, increasing or decreasing elevator speed may cause the elevator to arrive at the newly selected floor sooner/later. In the case of a medical emergency, increasing the speed of the elevator may reduce the amount of time until an elevator passenger can obtain medical assistance. Decreasing the speed may increase the amount of time available for security personnel to arrive at the newly selected floor. As yet another example modification, an intercom within the elevator may be automatically enabled. In the case where there may be a person trapped in an elevator due to a malfunction an intercom may be enabled to allow the building security personnel to be able to communicate with those trapped in the elevator in order to encourage them to remain calm. This can be especially beneficial in the case where children have become accidently trapped in an elevator without an understanding of how the elevator works (e.g. separated from their parents, etc.).

In yet another example, modifying the elevator workflow includes automatically controlling the elevator to the nearest floor with security. As explained above, it may be beneficial to direct an elevator to a destination floor where security and/or law enforcement may be waiting to apprehend an individual involved in an incident within the elevator. As yet another example, modifying the elevator workflow may include automatically directing the elevator to a floor with exits. In many buildings there may be exits to the building located on different levels. For example, for a building on a hill, there may be an exit to the front of a building on the ground floor, while an exit to the rear of the building may be on a third floor. If the incident type is such that people should be evacuating the building (e.g. active shooter, etc.) the floor may be selected to provide the quickest path to exit the building by selecting floor which include exits.

Although several examples of elevator workflow modifications have been described, it should be understood that this was not intended to be an exhaustive list. What should be understood is that once an incident has been identified, the elevator workflow may be modified based on the type of incident, as well as the risk involved, as well as the severity of the incident.

In block 235, the floor selection is displayed while modifying the elevator workflow to a different floor. In other words, from the interior of the elevator, all appears as if the elevator is still on the way to the initial floor selection, even though the workflow has been modified to cause the elevator to go to a different floor. The reason that this is done is to prevent people within the elevator from realizing that the behavior they are engaged in that has caused the incident has been detected. Thus, in the case where security personnel are preparing to apprehend an individual involved in an incident, that individual is not made aware that a response awaits them on a different floor (i.e. they are not aware they are being sent to a different floor.).

In block 240, a security notification indicative of the incident type and the automatic modification of the elevator workflow is sent. The security notification informs authorities that there has been an incident detected within an elevator and that the elevator is being directed to a different floor than originally selected, is being directed to a ground floor, or any other type of modification to the originally selected floor. The indication may also include if the elevator is being sped up/down, frozen in place, doors kept closed, etc.

In block 245, the security notification is sent to a public safety answering point (PSAP). A PSAP is a place where public safety responders (e.g. police, fire department, EMS) are dispatched to respond to incidents. The PSAP may receive the indication and determine that a public safety response is required. For example, in the case of a medical emergency, the PSAP may be informed that the incident type is a medical incident and the elevator workflow is modified to cause the elevator to return to the ground floor. The PSAP may then dispatch EMS resources to the ground floor of the building including the elevator. As yet another example, in the case of an active shooter, the PSAP may dispatch law enforcement to the location specified.

In block 250, the PSAP can override the modified elevator workflow execution. For example, the modified elevator workflow may indicate that the elevator is being sent to the ground floor. However, there may already be public safety resources located at a different floor in the building. In such cases, the PSAP may override the building elevator control system and direct the elevator to the floor where public safety resources are already available.

In block 255, security personnel are dispatched to the different floor. As explained above, a building may have its own security personnel. When an incident occurs within an elevator, the building security personnel may be dispatched to the different floor selected by the elevator control system. In other words, the security personnel are dispatched such that they will be ready for the arrival of the elevator at the floor selected by the elevator control system. For example, in the case of an active shooter, the building security personnel can be made aware they should expect to deal with a shooter when the elevator doors open. In the case of a medical emergency, the building security personnel are made aware they should prepare to respond to a medical issue.

In block 260, a door of the elevator is kept closed until security personnel have arrived at the different floor. Once dispatched, it may take some time for building security personnel to arrive at the different floor (e.g. need to take stairs to get to the floor, need to take a different elevator, need to gather proper equipment for responding to the incident, etc.). If the elevator doors were to open prior to the building security personnel's arrival, a person involved in the incident may flee and may not be captured/assisted. By keeping the elevator doors closed until the arrival of the building security personnel, it can be assured that all participants involved in the incident will still be contained within the elevator. It should be understood that the ability to keep the doors closed also applies to the dispatch of personnel by a PSAP.

In block 265, at least a portion of a feed from the video camera is sent to a device associated with security personnel. As described above, video cameras may be used to detect incidents occurring within an elevator. It would be useful to share the video of what caused an incident to be detected with those responding to the incident. For example, if a weapon was detected, an image of the detected weapon may be sent to a device (e.g. a smartphone, etc.) associated with the security personnel so that they can see what triggered the incident and are better able to prepare for whatever comes out of the elevator. The type of images sent from the video system can include still images, short video clips, and/or a real time video stream of what is currently occurring within the elevator.

In block 270, other elevators may be prevented from stopping on the different floor. As mentioned above, in all but the smallest of buildings there may be more than one elevator available to provide service. In many cases, depending on the type of incident, it may be desirable to limit other elevators from stopping on the same floor where an elevator with an active incident is being directed. For example, if an elevator with an active shooter contained within is directed to the tenth floor, it would be desirable to prevent all other elevators from stopping on the tenth floor. By preventing the other elevators from stopping on the different floor, it is not possible for those people to become unwitting participants in the incident.

In block 275, the elevator may be removed from service, wherein removing the elevator from service prevents the elevator from responding to additional calls. Elevators are designed to respond to calls (e.g. requests for service, etc.) in the most efficient manner possible. For example, a person may get on an elevator on the ground floor and select the tenth floor as a destination. A person on the fourth floor may press a button indicating that he wishes to go to a higher floor in the building (e.g. a call/request for service). If the elevator has not yet passed the fourth floor, it would be efficient for the elevator to stop on the fourth floor to service the call.

However, if there is an incident occurring in the elevator, it may make the situation more dangerous by putting additional people at risk. For example, if there is an active shooter in the elevator, stopping to pick up additional passengers would put those passengers at risk. By removing the elevator from service, it is ensured that no additional people are placed at risk.

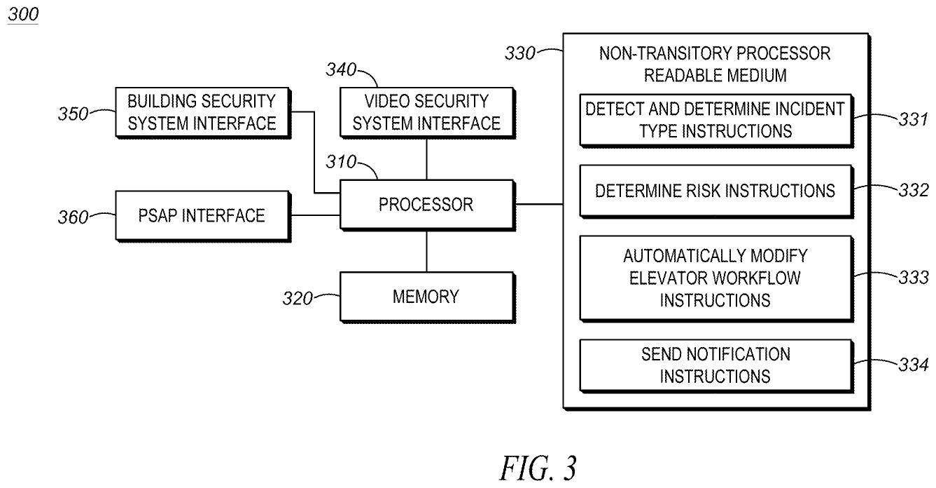

FIG. 3 is an example of a device 300 that may be used to implement the techniques described herein. It should be understood that FIG. 3 represents one example implementation of a computing device that utilizes the techniques described herein. Although only a single processor is shown, it would be readily understood that a person of skill in the art would recognize that distributed implementations are also possible. For example, the various pieces of functionality described above (e.g. video analytics, elevator workflow modification, etc.) could be implemented on multiple devices that are communicatively coupled. FIG. 3 is not intended to imply that all the functionality described above must be implemented on a single device.

Device 300 may include processor 310, memory 320, non-transitory processor readable medium 330, video security system interface 340, building security system interface 350, and PSAP interface 360.

Processor 310 may be coupled to memory 320. Memory 320 may store a set of instructions that when executed by processor 310 cause processor 310 to implement the techniques described herein. Processor 310 may cause memory 320 to load a set of processor executable instructions from non-transitory processor readable medium 330. Non-transitory processor readable medium 330 may contain a set of instructions thereon that when executed by processor 310 cause the processor to implement the various techniques described herein.

For example, medium 330 may include detect and determine incident type instructions 331. The detect and determine incident type instructions 331 may cause the processor to utilize the video security system interface 340 to detect incidents occurring within an elevator through the use of video cameras within the elevator and determine the type of incident. The detect and determine incident type instructions 331 are described generally throughout the specification, including places such as the description of blocks 205 and 210.

The medium 330 may include determine risk instructions 332. The determine risk instructions 332 may cause the processor to use the video security system interface 340 to access cameras in the elevator as well as cameras covering the elevator lobbies (to determine risks for people not on the elevator). For example, the risks to people simply waiting for an elevator to arrive. The determine risk instructions 332 are described generally throughout the specification, including places such as the description of block 215.

The medium 330 may include automatically modify elevator workflow instructions 333. The automatically modify elevator workflow instructions 333 may cause the elevator to go to a different floor than the originally selected destination floor. The modification may be based on many factors, including the incident type and risks determined previously. The automatically modify elevator workflow instructions 333 are described generally throughout the specification, including places such as the description of blocks 220-235, 260, 270, and 275.

The medium 330 may include send notification instructions 334. The send notification instructions 334 may cause the processor to send notifications to the building security system via the building security system 350 interface or to the PSAP via the PSAP interface 360. The notifications may cause either security personnel to PSAP personnel to respond to a floor of the building based on the modifications to the elevator workflow described above. The send notification instructions 334 are described generally throughout the specification, including places such as the description of blocks 240-250, 255, and 265.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot identify incidents using video analytics or automatically interface with an elevator control system to modify elevator workflows based on incidents and risk, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
detecting, via a video camera, an incident occurring within an elevator;
determining incident type using video analytics;
determining that a floor selection associated with the incident type will place at least one of elevator passengers or people on the selected floor at risk;
automatically modifying elevator workflow execution based on the incident type and risk associated with the floor selection;
displaying the floor selection, while modifying the elevator workflow to a different floor; and
sending a security notification indicative of the incident type and the automatic modification of the elevator workflow.

2. The method of claim 1 wherein automatically modifying the elevator workflow execution based on incident type is further based on a determination of an incident severity.

3. The method of claim 1 wherein automatically modifying elevator workflow execution comprises at least one of:
stopping the elevator;
modifying elevator floor destination;
modifying elevator floor destination in conjunction with a false destination indicator;
increasing or decreasing elevator speed;
automatically enabling an intercom;
automatically controlling the elevator to nearest floor with security; and
automatically directing the elevator to a floor with exits.

4. The method of claim 1 wherein the security notification is sent to a public safety answering point (PSAP).

5. The method of claim 4 wherein the PSAP can override the modified elevator workflow execution.

6. The method of claim 1, further comprising:
dispatching security personnel to the different floor.

7. The method of claim 6 further comprising:
keeping a door of the elevator closed until security personnel have arrived at the different floor.

8. The method of claim 6 further comprising:
sending at least a portion of a feed from the video camera to a device associated with security personnel.

9. The method of claim 1 further comprising:
preventing other elevators from stopping on the different floor.

10. The method of claim 1 further comprising:
removing the elevator from service, wherein removing the elevator from service prevents the elevator from responding to additional calls.

11. A system comprising:
a processor; and
a memory coupled to the processor, the memory containing a set of instructions thereon that when executed by the processor cause the processor to:
detect, via a video camera, an incident occurring within an elevator;
determine incident type using video analytics;
determine that a floor selection associated with the incident type will place at least one of elevator passengers or people on the selected floor at risk;
automatically modify elevator workflow execution based on the incident type and risk associated with the floor selection;
display the floor selection, while modifying the elevator workflow to a different floor; and
send a security notification indicative of the incident type and the automatic modification of the elevator workflow.

12. The system of claim 11, further comprising instructions that cause the processor to:
dispatch security personnel to the different floor.

13. The system of claim 12 further comprising instructions that cause the processor to:
keep a door of the elevator closed until security personnel have arrived at the different floor.

14. The system of claim 11, further comprising instructions that cause the processor to:
prevent other elevators from stopping on the different floor.

15. The system of claim 11, further comprising instructions that cause the processor to:
remove the elevator from service, wherein removing the elevator from service prevents the elevator from responding to additional calls.

16. A non-transitory processor readable medium containing a set of instructions thereon that when executed by a processor cause the processor to:
detect, via a video camera, an incident occurring within an elevator;
determine incident type using video analytics;
determine that a floor selection associated with the incident type will place at least one of elevator passengers or people on the selected floor at risk;
automatically modify elevator workflow execution based on the incident type and risk associated with the floor selection;
display the floor selection, while modifying the elevator workflow to a different floor; and
send a security notification indicative of the incident type and the automatic modification of the elevator workflow.

17. The non-transitory medium of claim 16, further comprising instructions that cause the processor to:
dispatch security personnel to the different floor.

18. The non-transitory medium of claim 17 further comprising instructions that cause the processor to:
keep a door of the elevator closed until security personnel have arrived at the different floor.

19. The non-transitory medium of claim 16, further comprising instructions that cause the processor to:
prevent other elevators from stopping on the different floor.

20. The non-transitory medium of claim 16, further comprising instructions that cause the processor to:
remove the elevator from service, wherein removing the elevator from service prevents the elevator from responding to additional calls.
